(19) United States
(12) Patent Application Publication
(10) Pub. No.: US 2019/0210151 A1
(43) Pub. Date: Jul. 11, 2019

(54) SYSTEMS AND METHODS FOR ADDITIVE MANUFACTURING USING PRESSURIZED CONSOLIDATION DEVICES

(71) Applicant: General Electric Company, Schenectady, NY (US)

(72) Inventors: Andrew David Deal, Overland Park, KS (US); Evan Dozier, Niskayuna, NY (US); Scott Michael Oppenheimer, Schenectady, NY (US); Jason Harris Karp, Niskayuna, NY (US); David Charles Bogdan, JR., Charlton, NY (US)

(21) Appl. No.: 15/864,055

(22) Filed: Jan. 8, 2018

(51) Int. Cl. B23K 26/342; B33Y 10/00; B33Y 30/00; B29C 64/153; B29C 64/20; B29C 64/364; B28B 1/00; B33Y 40/00; B23K 26/12

(52) U.S. Cl. CPC B23K 26/342; B33Y 10/00; B33Y 30/00; B29C 64/153; B29C 64/20; C03B 19/01; B28B 1/001; B33Y 40/00; B23K 26/123; B23K 26/127; B29C 64/364

(57) ABSTRACT

A pressurized consolidation assembly for an additive manufacturing system is provided. The pressurized consolidation assembly defines a first direction, a second direction, and a third direction, the three directions orthogonal to each other. The pressurized consolidation assembly includes a build platform configured to hold a plurality of particles and a pressure chamber surrounding the build platform. The pressure chamber is configured to retain a first volume of a gas having a first pressure. The pressure chamber includes an energy beam window. The energy beam window extends through a first section of the pressure chamber and is configured to enable an energy beam to pass through the energy beam window to be incident on the plurality of particles on the build platform.

### BACKGROUND

The subject matter described herein relates generally to additive manufacturing systems and, more particularly, to additive manufacturing systems including pressurized consolidation apparatuses.

At least some additive manufacturing systems involve the consolidation of a particulate material to make a component. Such techniques facilitate producing complex components from expensive materials at a reduced cost and with improved manufacturing efficiency. At least some known additive manufacturing systems, such as Direct Metal Laser Melting (DMLM), Selective Laser Melting (SLM), Direct Metal Laser Sintering (DMLS), and LaserCusing® systems, fabricate components using a focused energy source, such as a laser device or an electron beam generator, a build platform, and a particulate, such as, without limitation, a powdered metal. (LaserCusing is a registered trademark of Concept Laser GmbH of Lichtenfels, Germany.) In at least some DMLM systems, a melt pool is formed in the particulate by the focused energy source and the particulate is consolidated to form a build layer of the component on the build platform at an atmospheric pressure. However, in at least some known systems, a plurality of spatter particles created during the consolidation of the particulate are ejected from an area surrounding the melt pool and impact non-consolidated portions of the particulate, disturbing a precisely arranged layer of particulate that will be used to form the build layer, which may result in dimensional and surface finish inconsistencies in the completed component.

### BRIEF DESCRIPTION

In one aspect, a pressurized consolidation assembly for an additive manufacturing system is provided. The pressurized consolidation assembly defines a first direction, a second direction, and a third direction, the three directions orthogonal to each other. The pressurized consolidation assembly includes a build platform configured to hold a plurality of particles and a pressure chamber surrounding the build platform. The pressure chamber is configured to retain a first volume of a gas having a first pressure. The pressure chamber includes at least one energy beam window. The at least one energy beam window extends through a first section of the pressure chamber and is configured to enable an energy beam to pass through the at least one energy beam window to be incident on the plurality of particles on the build platform.

In another aspect, an additive manufacturing system is provided. The additive manufacturing system defines a first, longitudinal direction, a second, transverse direction, and a third, vertical direction. The additive manufacturing system includes a consolidation device configured to emit an energy beam and a pressurized consolidation assembly. The pressurized consolidation assembly includes a build platform configured to hold a plurality of particles and a pressure chamber surrounding the build platform. The pressure chamber is configured to retain a first volume of a gas having a first pressure. The pressure chamber includes at least one energy beam window. The at least one energy beam window extends through a first section of the pressure chamber and is configured to enable an energy beam to pass through the at least one energy beam window to be incident on the plurality of particles on the build platform.

In yet another aspect, an additive manufacturing system is provided. The additive manufacturing system defines a first, longitudinal direction, a second, transverse direction, and a third, vertical direction. The additive manufacturing system includes a consolidation device configured to emit an energy beam and a pressurized consolidation assembly. The pressurized consolidation assembly includes a build platform configured to hold a plurality of particles and a pressure chamber surrounding the build platform and the consolidation device. The pressure chamber is configured to retain a first volume of a gas having a first pressure.

In yet another further aspect, a method of fabricating a component using an additive manufacturing system is provided. The method includes pressurizing a pressurized consolidation assembly, wherein the pressurized consolidation assembly includes a build platform configured to hold a plurality of particles and a pressure chamber surrounding the build platform. The pressure chamber is configured to retain a first volume of a gas having a first pressure. The pressure chamber includes at least one energy beam window. The at least one energy beam window extends through a first section of the pressure chamber and is configured to enable an energy beam to pass through the at least one energy beam window to be incident on the plurality of particles on the build platform. The method also includes depositing a plurality of particles onto the build platform. The method further includes distributing the plurality of particles to form a build layer. Finally, the method includes operating a consolidation device to direct at least one energy beam through the at least one energy beam window to consolidate at least a portion of the build layer.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary additive manufacturing system;

FIG. 2 is a block diagram of a controller that may be used to operate the additive manufacturing system shown in FIG. 1;

FIG. 3 is a schematic side view of the additive manufacturing system shown in FIG. 1 illustrating an exemplary pressurized consolidation assembly;

FIG. 4 is a top view of the pressurized consolidation assembly shown in FIG. 3;

FIG. 5 is a section view of the pressurized consolidation assembly shown in FIG. 3 taken about section line 5-5 illustrating exemplary plasma plumes and exemplary minimum spatter ejection angles; and

FIG. 6 is a flowchart illustrating an exemplary method that may be used to fabricate a component using the additive manufacturing system shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and methods described herein include a pressurized consolidation assembly for an additive manufacturing system. The pressurized consolidation assembly defines a first direction, a second direction, and a third direction, the three directions orthogonal to each other. The pressurized consolidation assembly includes a build platform configured to hold a plurality of particles, and a pressure chamber. The pressure chamber surrounds the build platform and is configured to retain a first volume of a gas having a pressure. The pressure chamber includes at least one energy beam window. The at least one energy beam window extends through a first section of the pressure chamber and is configured to enable an energy beam to pass through the at least one energy beam window to be incident on the plurality of particles on the build platform. The pressurized consolidation assembly facilitates reducing the cost to additively manufacture components and improving the quality of the additively manufactured components by reducing the frequency and magnitude of interactions between spatter formed during the additive manufacturing process and the plurality of particles on the build platform.

Additive manufacturing processes and systems include, for example, and without limitation, vat photopolymerization, powder bed fusion, binder jetting, material jetting, sheet lamination, material extrusion, directed energy deposition and hybrid systems. These processes and systems include, for example, and without limitation, SLA—Stereolithography Apparatus, DLP—Digital Light Processing, 3SP—Scan, Spin, and Selectively Photocure, CLIP—Continuous Liquid Interface Production, SLS—Selective Laser Sintering, DMLS—Direct Metal Laser Sintering, SLM—Selective Laser Melting, EBM—Electron Beam Melting, SHS—Selective Heat Sintering, MJF—Multi-Jet Fusion, 3D Printing, Voxeljet, Polyjet, SCP Smooth Curvatures Printing, MJM—Multi-Jet Modeling Project, LOM—Laminated Object Manufacture, SDL—Selective Deposition Lamination, UAM—Ultrasonic Additive Manufacturing, FFF—Fused Filament Fabrication, FDM—Fused Deposition Modeling, LMD—Laser Metal Deposition, LENS—Laser Engineered Net Shaping, DMD—Direct Metal Deposition, Hybrid Systems, and combinations of these processes and systems. These processes and systems may employ, for example, and without limitation, all forms of electromagnetic radiation, heating, sintering, melting, curing, binding, consolidating, pressing, embedding, and combinations thereof.

Additive manufacturing processes and systems employ materials including, for example, and without limitation, polymers, plastics, metals, ceramics, sand, glass, waxes, fibers, biological matter, composites, and hybrids of these materials. These materials may be used in these processes and systems in a variety of forms as appropriate for a given material and the process or system, including, for example, and without limitation, as liquids, solids, powders, sheets, foils, tapes, filaments, pellets, liquids, slurries, wires, atomized, pastes, and combinations of these forms.

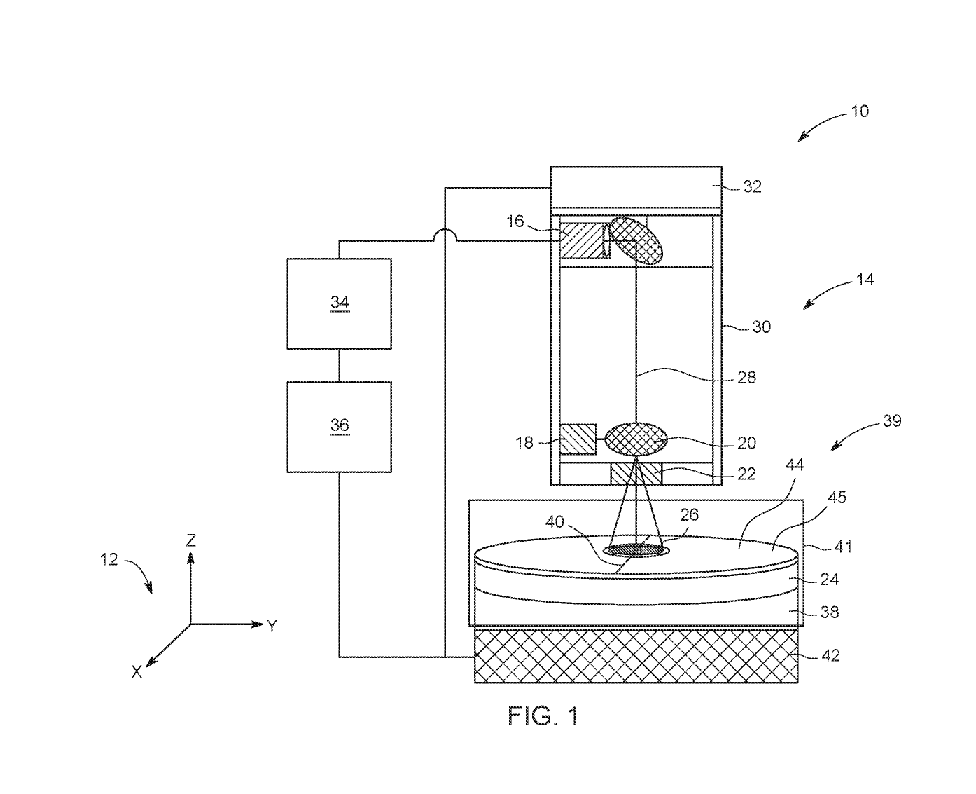

FIG. 1 is a schematic view of an exemplary additive manufacturing system 10. A coordinate system 12 includes an X-axis, a Y-axis, and a Z-axis. In the exemplary embodiment, additive manufacturing system 10 includes a consolidation device 14 including a laser device 16, a scanning motor 18, a scanning mirror 20, and a scanning lens 22 for fabricating a component 24 using a layer-by-layer manufacturing process. Alternatively, consolidation device 14 may include any component that facilitates consolidation of a material using any of the processes and systems described herein. Laser device 16 provides a high-intensity heat source configured to generate a melt pool 26 (not shown to scale) in a powdered material using an energy beam 28. Specifically, laser device 16 is a yttrium-based solid state laser device 16 configured to emit a laser beam 28 having a wavelength of about 1070 nanometers (nm). In alternative embodiments, consolidation device 14 may include any type of energy source that facilitates operation of additive manufacturing system 10 as described herein. Laser device 16 is contained within a housing 30 that is coupled to a mounting system 32. Additive manufacturing system 10 also includes a computer control system, or controller 34.

Mounting system 32 is moved by an actuator or an actuator system 36 that is configured to move mounting system 32 in the X-direction, the Y-direction, and the Z-direction to cooperate with scanning mirror 20 to facilitate fabricating a layer of component 24 within additive manufacturing system 10. For example, and without limitation, mounting system 32 is pivoted about a central point, moved in a linear path, a curved path, and/or rotated to cover a portion of the powder on a build platform 38 to facilitate directing energy beam 28 along the surface of a plurality of particles 45 of a build layer 44 to form a layer of component 24 within a pressure chamber 41 of a pressurized consolidation assembly 39. Alternatively, housing 30 and energy beam 28 are moved in any orientation and manner that enables additive manufacturing system 10 to function as described herein.

Scanning motor 18 is controlled by controller 34 and is configured to move mirror 20 such that energy beam 28 is reflected through a portion of pressurized consolidation assembly 39 to be incident along a predetermined path along build platform 38, such as, for example, and without limitation, a linear and/or rotational scan path 40. In the exemplary embodiment, the combination of scanning motor 18 and scanning mirror 20 forms a two-dimension scan galvanometer. Alternatively, scanning motor 18 and scanning mirror 20 may include a three-dimension (3D) scan galvanometer, dynamic focusing galvanometer, and/or any other method that may be used to deflect energy beam 28 of laser device 16.

In the exemplary embodiment, build platform 38 is mounted within pressurized consolidation assembly 39. Pressurized consolidation assembly 39 is coupled to a support structure 42, which is moved by actuator system 36. As described above with respect to mounting system 32, actuator system 36 is also configured to move support structure 42 in a Z-direction (i.e., normal to a top surface of build platform 38). In some embodiments, actuator system 36 is also configured to move support structure 42 in the XY plane. For example, and without limitation, in an alternative embodiment where housing 30 is stationary, actuator system 36 moves support structure 42 in the XY plane to cooperate with scanning motor 18 and scanning mirror 20 to direct energy beam 28 of laser device 16 along scan path 40 about build platform 38. In the exemplary embodiment, actuator system 36 includes, for example, and without limitation, a linear motor(s), a hydraulic and/or pneumatic piston(s), a screw drive mechanism(s), and/or a conveyor system.

In the exemplary embodiment, additive manufacturing system 10 is operated to fabricate component 24 from a computer modeled representation of the 3D geometry of component 24. The computer modeled representation may be produced in a computer aided design (CAD) or similar file. The CAD file of component 24 is converted into a layer-by-layer format that includes a plurality of build parameters for each layer of component 24, for example, build layer 44 of component 24 including plurality of particles 45 to be consolidated by additive manufacturing system 10. In the exemplary embodiment, component 24 is modeled in a desired orientation relative to the origin of the coordinate system used in additive manufacturing system 10. The geometry of component 24 is sliced into a stack of layers of a desired thickness, such that the geometry of each layer is an outline of the cross-section through component 24 at that particular layer location. Scan paths 40 are generated across the geometry of a respective layer. The build parameters are applied along scan path 40 to fabricate that layer of component 24 from particles 45 used to construct component 24. The steps are repeated for each respective layer of component 24 geometry. Once the process is completed, an electronic computer build file (or files) is generated, including all of the layers. The build file is loaded into controller 34 of additive manufacturing system 10 to control the system during fabrication of each layer.

After the build file is loaded into controller 34, additive manufacturing system 10 is operated to generate component 24 by implementing the layer-by-layer manufacturing process, such as a direct metal laser melting method. The exemplary layer-by-layer additive manufacturing process does not use a pre-existing article as the precursor to the final component, rather the process produces component 24 from a raw material in a configurable form, such as particles 45. For example, and without limitation, a steel component can be additively manufactured using a steel powder. Additive manufacturing system 10 enables fabrication of components, such as component 24, using a broad range of materials, for example, and without limitation, metals, ceramics, glass, and polymers.

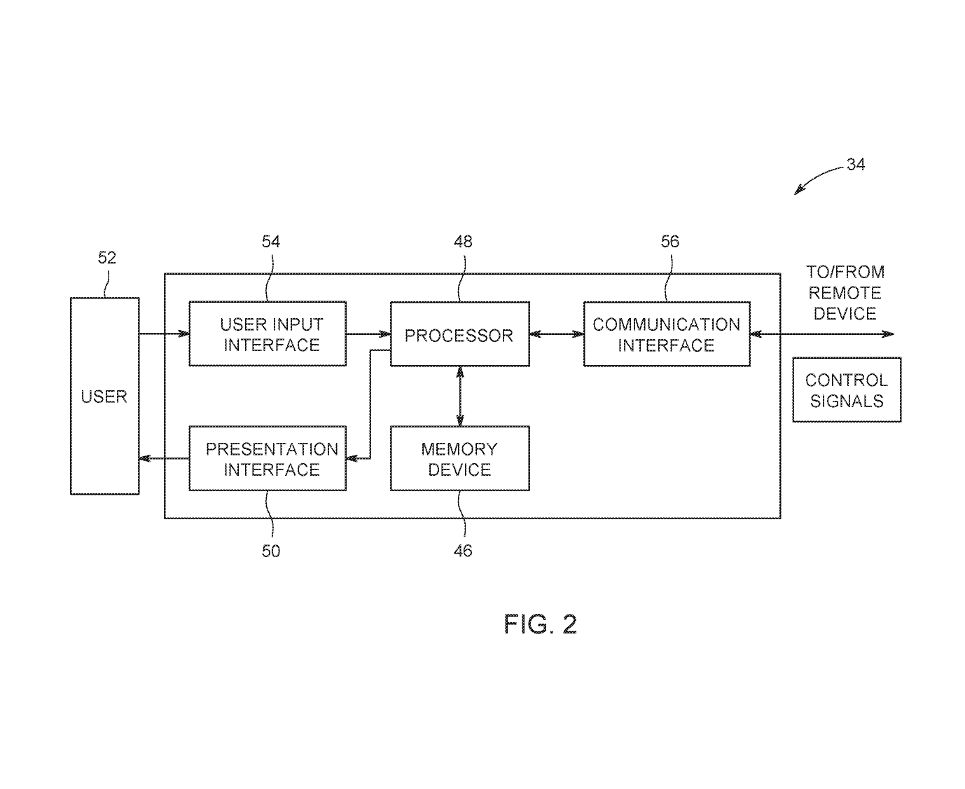

FIG. 2 is a block diagram of controller 34 that may be used to operate additive manufacturing system 10 (shown in FIG. 1). In the exemplary embodiment, controller 34 is any type of controller typically provided by a manufacturer of additive manufacturing system 10 to control operation of additive manufacturing system 10. Controller 34 executes operations to control the operation of additive manufacturing system 10 based at least partially on instructions from human operators. Controller 34 includes, for example, a 3D model of component 24 to be fabricated by additive manufacturing system 10. Operations executed by controller 34 include controlling power output of laser device 16 (shown in FIG. 1) and adjusting mounting system 32 and/or pressurized consolidation assembly 39, via actuator system 36 (all shown in FIG. 1) to control the scanning velocity of energy beam 28. Controller 34 is also configured to control scanning motor 18 to direct scanning mirror 20 to further control the scanning velocity of energy beam 28 within additive manufacturing system 10. In alternative embodiments, controller 34 may execute any operation that enables additive manufacturing system 10 to function as described herein.

In the exemplary embodiment, controller 34 includes a memory device 46 and a processor 48 coupled to memory device 46. Processor 48 may include one or more processing units, such as, without limitation, a multi-core configuration. Processor 48 is any type of processor that permits controller 34 to operate as described herein. In some embodiments, executable instructions are stored in memory device 46. Controller 34 is configurable to perform one or more operations described herein by programming processor 48. For example, processor 48 may be programmed by encoding an operation as one or more executable instructions and providing the executable instructions in memory device 46. In the exemplary embodiment, memory device 46 is one or more devices that enable storage and retrieval of information such as executable instructions or other data. Memory device 46 may include one or more computer readable media, such as, without limitation, random access memory (RAM), dynamic RAM, static RAM, a solid-state disk, a hard disk, read-only memory (ROM), erasable programmable ROM, electrically erasable programmable ROM, or non-volatile RAM memory. The above memory types are exemplary only, and are thus not limiting as to the types of memory usable for storage of a computer program.

Memory device 46 may be configured to store any type of data, including, without limitation, build parameters associated with component 24. In some embodiments, processor 48 removes or “purges” data from memory device 46 based on the age of the data. For example, processor 48 may overwrite previously recorded and stored data associated with a subsequent time or event. In addition, or alternatively, processor 48 may remove data that exceeds a predetermined time interval. In addition, memory device 46 includes, without limitation, sufficient data, algorithms, and commands to facilitate monitoring of build parameters and the geometric conditions of component 24 being fabricated by additive manufacturing system 10.

In some embodiments, controller 34 includes a presentation interface 50 coupled to processor 48. Presentation interface 50 presents information, such as the operating conditions of additive manufacturing system 10, to a user 52. In one embodiment, presentation interface 50 includes a display adapter (not shown) coupled to a display device (not shown), such as a cathode ray tube (CRT), a liquid crystal display (LCD), an organic LED (OLED) display, or an “electronic ink” display. In some embodiments, presentation interface 50 includes one or more display devices. In addition, or alternatively, presentation interface 50 includes an audio output device (not shown), for example, without limitation, an audio adapter or a speaker (not shown).

In some embodiments, controller 34 includes a user input interface 54. In the exemplary embodiment, user input interface 54 is coupled to processor 48 and receives input from user 52. User input interface 54 may include, for example, without limitation, a keyboard, a pointing device, a mouse, a stylus, a touch sensitive panel, such as, without limitation, a touch pad or a touch screen, and/or an audio input interface, such as, without limitation, a microphone. A single component, such as a touch screen, may function as both a display device of presentation interface 50 and user input interface 54.

In the exemplary embodiment, a communication interface 56 is coupled to processor 48 and is configured to be coupled in communication with one or more other devices, such as laser device 16, and to perform input and output operations with respect to such devices while performing as an input channel. For example, communication interface 56 may include, without limitation, a wired network adapter, a wireless network adapter, a mobile telecommunications adapter, a serial communication adapter, or a parallel communication adapter. Communication interface 56 may receive a data signal from or transmit a data signal to one or more remote devices. For example, in some embodiments, communication interface 56 of controller 34 may transmit/receive a data signal to/from actuator system 36.

Presentation interface 50 and communication interface 56 are both capable of providing information suitable for use with the methods described herein, such as, providing information to user 52 or processor 48. Accordingly, presentation interface 50 and communication interface 56 may be referred to as output devices. Similarly, user input interface 54 and communication interface 56 are capable of receiving information suitable for use with the methods described herein and may be referred to as input devices.

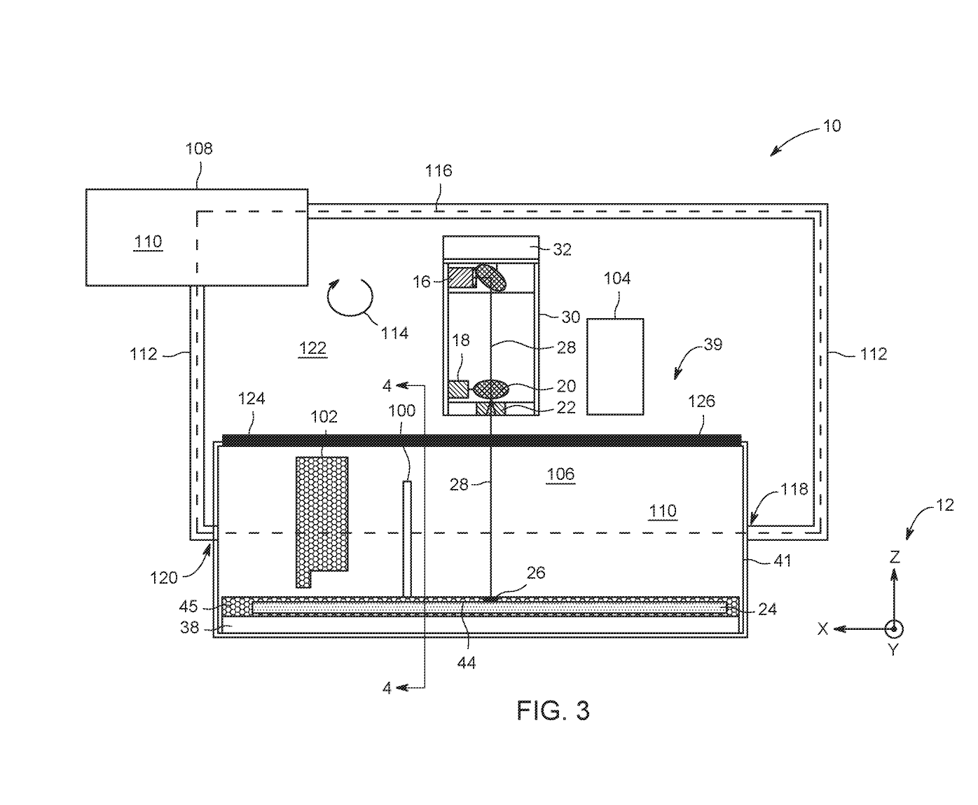

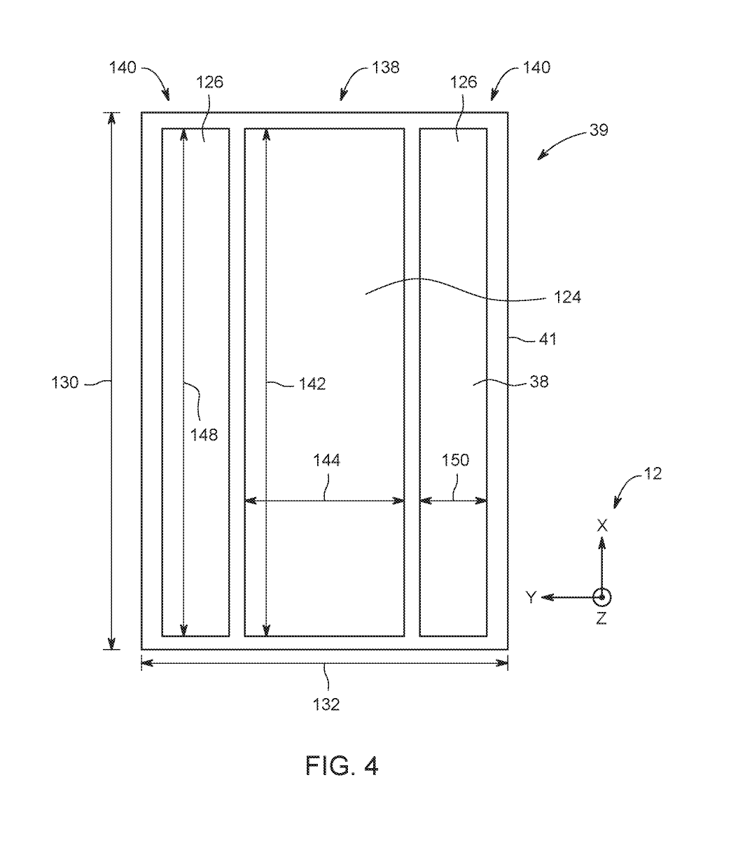

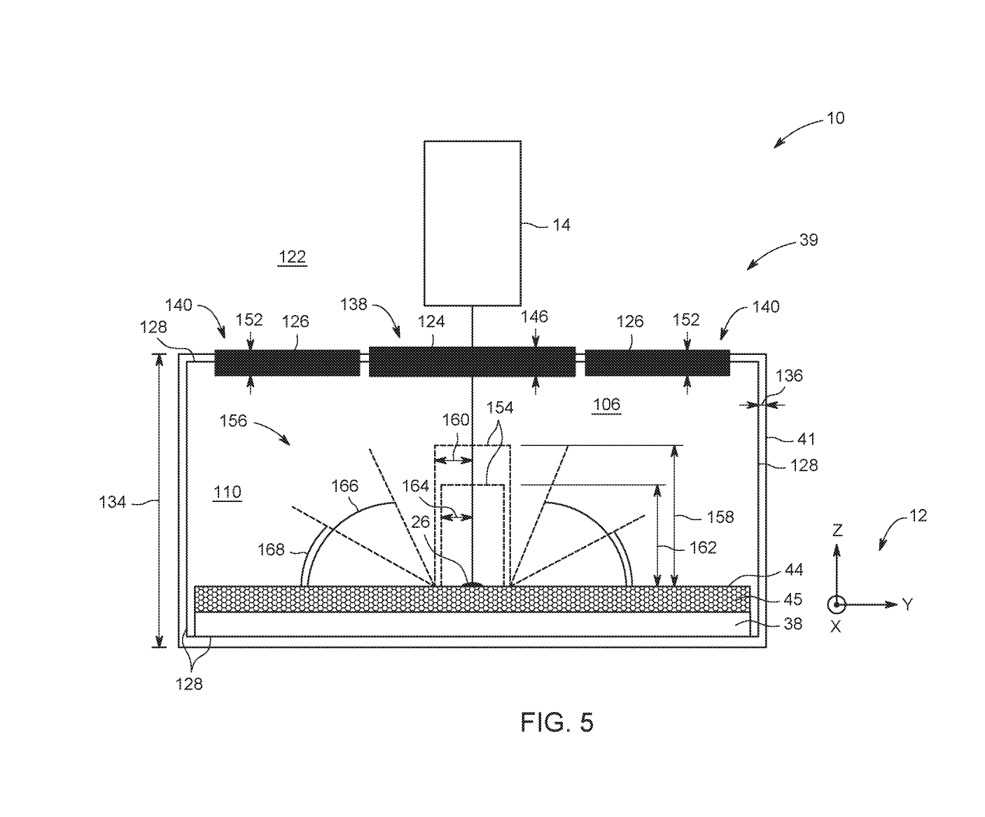

FIG. 3 is a schematic side view of additive manufacturing system 10 (shown in FIG. 1) illustrating pressurized consolidation assembly 39. FIG. 4 is a top view of pressurized consolidation assembly 39 (shown in FIG. 3). FIG. 5 is a section view of pressurized consolidation assembly 39 (shown in FIG. 3) taken about section line 4-4 illustrating exemplary plasma plumes 154 and exemplary minimum spatter ejection angles 156. In the exemplary embodiment, pressurized consolidation assembly 39 includes pressure chamber 41 including first volume 106 of gas 110, second volume 108 of gas 110, consolidation device 14, an optical system 104, and a plurality of gas pipes 112. Pressure chamber 41 includes a recoating device 100, a particle delivery device 102, and build platform 38. Particle delivery device 102 is configured to deliver particles 45 to build platform 38. Recoating device 100 is configured to distribute particles 45 across build platform 38 to form build layer 44. In alternative embodiments, any component of additive manufacturing system 10 may be located within pressurized consolidation assembly 39 that facilitates operation of additive manufacturing system 10 as described herein.

In the exemplary embodiment, pressure chamber 41 is coupled to second volume 108 of gas 110, wherein second volume 108 of gas 110 is in flow communication with first volume 106 of gas 110 within pressure chamber 41. In the exemplary embodiment, gas 110 flows along a flow direction 114 from second volume 108, through a plurality of gas pipes 112, through pressure chamber 41, and finally back to second volume 108, defining gas flowpath 116. In the exemplary embodiment, gas 110 enters pressure chamber 41 through a first opening 118 and exits pressure chamber 41 through a second opening 120 to facilitate providing a continuous supply of non-contaminated gas 110 to melt pool 26 during the additive manufacturing process. In an alternative embodiment, pressure chamber 41 is configured to release a portion of gas 110 to outer environment 122 to facilitate creating a continuous, positive over-pressure condition within pressure chamber 41. In another alternative embodiment, gas 110 flows from second volume 108 to pressure chamber 41 and is released from pressure chamber 41 to outer environment 122. In further alternative embodiments, gas 110 may follow any gas flowpath 116 through any components of additive manufacturing system 10 that facilitates operation of additive manufacturing system 10 as described herein.

In the exemplary embodiment, pressure chamber 41 includes an energy beam window 124 and two observation windows 126, and is configured to retain first volume 106 of gas 110 having a first pressure. In the exemplary embodiment, pressure chamber 41 is a hollow rectangular box including a plurality of pressure walls 128 including four sides and two ends. Pressure chamber 41 extends along the X-direction by a chamber length 130, along the Y-direction by a chamber width 132, and along the Z-direction by a chamber height 134. Each pressure wall 128 has a pressure wall thickness 136 and is configured to resist deformation resulting at least from a pressure differential between first volume 106 of gas 110 and outer environment 122. In alternative embodiments, pressure chamber 41 may have any shape and include any pressure walls 128, energy beam windows 124, and observation windows 126 that facilitate operation of additive manufacturing system 10 as described herein.

In the exemplary embodiment, energy beam window 124 extends through a first section 138 of pressure wall 128 of pressure chamber 41 and has an energy beam window length 142, an energy beam window width 144, and an energy beam window thickness 146. Each observation window 126 extends through a second section 140 of pressure chamber 41 and has an observation window length 148, an observation window width 150, and an observation window thickness 152. In the exemplary embodiment, energy beam window 124 and observation windows 126 are located in the same pressure wall 128 of pressure chamber 41. In alternative embodiments, pressure chamber 41 may include any type and number of energy beam windows 124 and observation windows 126, including zero, in any locations that facilitate operation of additive manufacturing system 10 as described herein.

In the exemplary embodiment, energy beam window 124 is configured to enable energy beam 28 to pass through energy beam window 124 to be incident on plurality of particles 45 on build platform 38 within pressure chamber 41. Each observation window 126 is configured to facilitate observation of plurality of particles 45 on build platform 38 within pressure chamber 41. More specifically, in the exemplary embodiment, energy beam window 124 is a fused silica window having a high degree of transmission of a laser beam having a wavelength of about 1070 nm. In the exemplary embodiment, observation windows 126 are acrylic windows having a high degree of transmission of wavelengths visible to manufacturing personnel and optical system 104 to facilitate monitoring of the consolidation of build layer 44 by energy beam 28 to facilitate controlling consolidation device 14 by controller 34. In alternative embodiments, energy beam window 124 and observation windows 126 may be any type of material and may have any degree of transmission of any wavelength of light that facilitates operation of additive manufacturing system 10 as described herein.

In the exemplary embodiment, gas 110 is a shielding gas, and, more particularly, gas 110 is argon. In alternative embodiments, gas 110 may be at least one of carbon dioxide, helium, oxygen, nitrogen, nitric oxide, sulfur hexafluoride, and dichlorodifluoromethane. In the exemplary embodiment, the first pressure of gas 110 within pressure chamber 41 is approximately one hundred pounds per square inch (psi). In alternative embodiments, the first pressure may be between approximately fourteen and a half psi (atmospheric conditions) and one hundred ten psi. During the consolidation process of build layer 44, melt pool 26 is formed by energy beam 28, causing plasma plume 154 to form between melt pool 26 and consolidation device 14 and an amount of spatter to be ejected radially outward from melt pool 26 above a minimum spatter ejection angle 156. Exposing melt pool 26 to an increased pressure, specifically a pressure that is above an atmospheric conditions pressure, facilitates modification of the properties of the spatter and plasma plume 154 to facilitate improving the consolidation of build layer 44. More particularly, an increase in the internal pressure within pressure chamber 41 facilitates a relatively smaller overall size and quantity of spatter ejected from melt pool 26, a lower minimum spatter ejection angle 156, and a larger plasma plume 154, as compared to consolidating build layer 44 at atmospheric conditions.

In the exemplary embodiment, spatter that interacts with non-consolidated portions of build layer 44 may inhibit consistent consolidation of build layer 44 and may inhibit creation of a proper surface finish and dimensional properties for component 24. Minimizing the size, quantity, ejection velocity, and minimum spatter ejection angle 156 of the spatter created during the additive manufacturing process facilitates improving the consistency of the additive manufacturing processing within additive manufacturing system 10. More specifically, reducing the size and quantity of the spatter facilitates reducing energy transferred to particles 45 by impacting spatter, facilitating reducing disruption of build layer 44. Reducing the ejection velocity and minimum spatter ejection angle 156 of the spatter facilitates reducing a distance traveled by the spatter and facilitates reducing disruption of build layer 44. Additionally, an increase in plasma plume 154 may facilitate interaction between plasma plume 154 and the spatter to facilitate reducing the ejection velocity of the spatter.

In the exemplary embodiment, with reference to FIG. 5, during operation of additive manufacturing system 10 when the pressure of gas 110 within pressure chamber 41 is approximately 100 psi, plasma plume 154 extends outward from melt pool 26 along the Z-direction by a first plume height 158 and radially outward in the X and Y-directions by a first plume radius 160. Spatter formed by energy beam 28 travels away from melt pool 26 at a plurality of angles, relative to the XY-plane, ranging from approximately ninety degrees to a first minimum spatter ejection angle 166. Alternatively, during operation of additive manufacturing system 10 when the pressure of gas 110 within pressure chamber 41 is at atmospheric conditions (approximately fourteen and a half psi), plasma plume 154 extends outward from melt pool 26 along the Z-direction by a second plume height 162 and radially outward in the X and Y-directions by a second plume radius 164. Spatter formed by energy beam 28 at atmospheric conditions travels away from melt pool 26 at a plurality of angles, relative to the XY-plane, ranging from approximately ninety degrees to a second minimum spatter ejection angle 168, wherein second minimum spatter ejection angle 168 is less than first minimum spatter ejection angle 166.

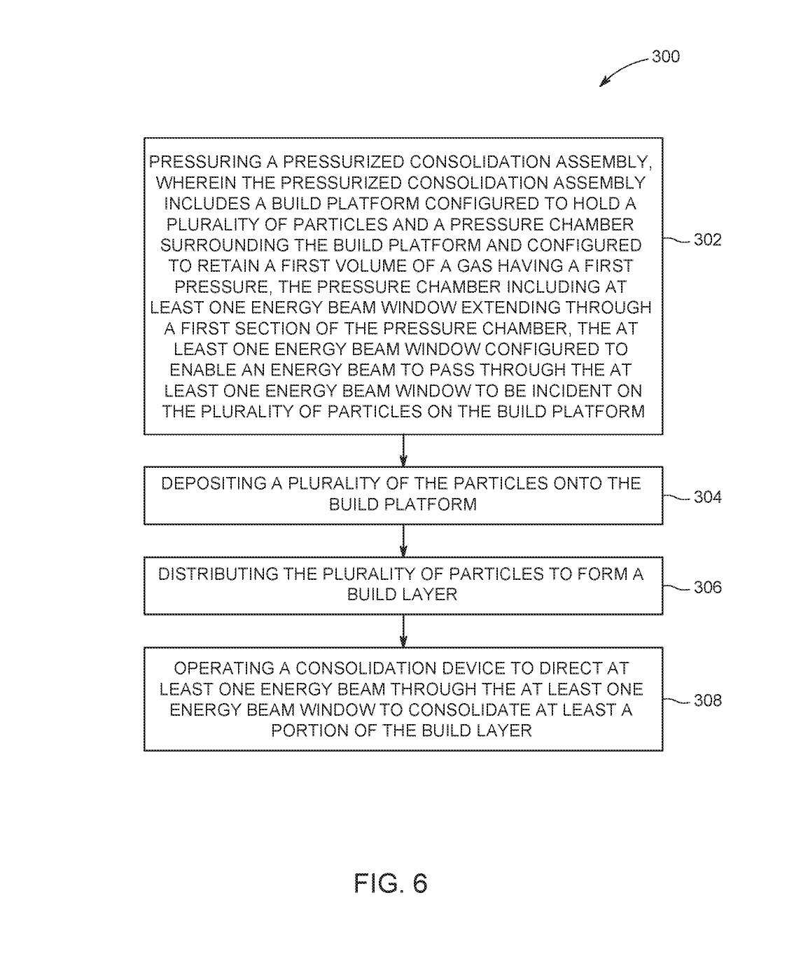

FIG. 6 is a flow chart illustrating a method 300 for fabricating a component 24 using additive manufacturing system 10 (shown in FIG. 1). Referring to FIGS. 1-6, method 300 includes pressurizing 302 a pressurized consolidation assembly 39, wherein pressurized consolidation assembly 39 includes a build platform 38 configured to hold a plurality of particles 45, and a pressure chamber 41. Pressure chamber 41 surrounds build platform 38 and is configured to retain a first volume 106 of gas 110 having a first pressure. Pressure chamber 41 includes at least one energy beam window 124 extending through a first section 138 of pressure chamber 41, wherein at least one energy beam window 124 is configured to enable an energy beam 28 to pass through at least one energy beam window 124 to be incident on plurality of particles 45 on build platform 38. Method 300 also includes depositing 304 a plurality of particles 45 onto build platform 38. Method 300 further includes distributing 306 plurality of particles 45 to form build layer 44. Method 300 further includes operating 308 a consolidation device 14 to direct at least one energy beam 28 through at least one energy beam window 124 to consolidate at least a portion of build layer 44.

The embodiments described herein include a pressurized consolidation assembly for an additive manufacturing system. The pressurized consolidation assembly defines a first direction, a second direction, and a third direction, the three directions orthogonal to each other. The pressurized consolidation assembly includes a build platform configured to hold a plurality of particles, and a pressure chamber. The pressure chamber surrounds the build platform and is configured to retain a first volume of a gas having a pressure. At least one energy beam window extends through a first section of the pressure chamber and is configured to enable an energy beam to pass through the at least one energy beam window to be incident on the plurality of particles on the build platform. The pressurized consolidation assembly facilitates reducing the cost to additively manufacture components and improving the quality of the additively manufactured components by reducing the frequency and magnitude of interactions between spatter formed during the additive manufacturing process and the plurality of particles on the build platform.

An exemplary technical effect of the methods, systems, and apparatus described herein includes at least one of: a) improving consistency of coverage of a component with particulate matter during the additive manufacturing process, b) reducing disturbance to the particulate matter during the additive manufacturing process, c) improving component dimensional and surface finish consistency, and d) reducing the cost of additively manufacturing a component.

Exemplary embodiments of pressurized consolidation assemblies that include build platforms and pressure chambers are described above in detail. The pressurized consolidation systems, and methods of using and manufacturing components with such systems are not limited to the specific embodiments described herein, but rather, components of systems and/or steps of the methods may be utilized independently and separately from other components and/or steps described herein. For example, the methods may also be used in combination with other additive manufacturing systems, and are not limited to practice with only the additive manufacturing systems, and methods as described herein. Rather, the exemplary embodiment can be implemented and utilized in connection with many other electronic systems.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A pressurized consolidation assembly for an additive manufacturing system, the pressurized consolidation assembly defining a first direction, a second direction, and a third direction, the three directions orthogonal to each other, said pressurized consolidation assembly comprising:
a build platform configured to hold a plurality of particles; and
a pressure chamber surrounding said build platform and configured to retain a first volume of a gas having a first pressure, said pressure chamber comprising:
at least one energy beam window extending through a first section of said pressure chamber, said at least one energy beam window configured to enable an energy beam to pass through said at least one energy beam window to be incident on the plurality of particles on said build platform.

2. The pressurized consolidation assembly in accordance with claim 1, wherein said pressure chamber further comprises at least one observation window extending through a second section of said pressure chamber, said at least one observation window configured to facilitate observation of the plurality of particles.

3. The pressurized consolidation assembly in accordance with claim 1, wherein the first pressure of the first volume of the gas is between approximately fourteen and a half (psi) and one hundred psi.

4. The pressurized consolidation assembly in accordance with claim 1, wherein the gas is a shielding gas, and wherein the shielding gas is at least one of argon, carbon dioxide, helium, oxygen, nitrogen, nitric oxide, sulfur hexafluoride, and dichlorodifluoromethane.

5. The pressurized consolidation assembly in accordance with claim 1, wherein said pressure chamber is coupled to a second volume of the gas, wherein the second volume of the gas is in flow communication with the first volume of the gas.

6. The pressurized consolidation assembly in accordance with claim 5, wherein said pressure chamber is configured to at least one of exchange at least a portion of the first volume of the gas with at least a portion of the second volume of the gas, and release a portion of the first volume of the gas from the pressure chamber and to receive a portion of the second volume of the gas.

7. The pressurized consolidation assembly in accordance with claim 1, wherein at least one of said pressure chamber and said build platform is configured to move in at least one of the first direction, the second direction, and the third direction.

8. An additive manufacturing system defining a first, longitudinal direction, a second, transverse direction, and a third, vertical direction, said additive manufacturing system comprising:
a consolidation device configured to emit an energy beam; and
a pressurized consolidation assembly comprising:
a build platform configured to hold a plurality of particles; and
a pressure chamber surrounding said build platform and configured to retain a first volume of a gas having a first pressure, said pressure chamber comprising:
at least one energy beam window extending through a first section of said pressure chamber, said at least one energy beam window configured to enable an energy beam to pass through said at least one energy beam window to be incident on the plurality of particles on said build platform.

9. The additive manufacturing system of claim 8, wherein said pressure chamber further comprises at least one observation window extending through a second section of said pressure chamber, said at least one observation window configured to facilitate observation of the plurality of particles.

10. The additive manufacturing system of claim 8, wherein the pressure of the first volume of the gas is between approximately fourteen and a half psi and one hundred psi.

11. The additive manufacturing system of claim 8, wherein the gas is a shielding gas, and wherein the shielding gas is at least one of argon, carbon dioxide, helium, oxygen, nitrogen nitric oxide, sulfur hexafluoride, and dichlorodifluoromethane.

12. The additive manufacturing system of claim 8, wherein said pressure chamber is coupled to a second volume of the gas, wherein the second volume of the gas is in flow communication with the first volume of the gas.

13. The additive manufacturing system of claim 12, wherein said pressure chamber is configured to exchange at least a portion of the first volume of the gas with at least a portion of the second volume of the gas.

14. The additive manufacturing system of claim 12, wherein said pressure chamber is configured to release a portion of the first volume of the gas from the pressure chamber and to receive a portion of the second volume of the gas.

15. The additive manufacturing system of claim 8, wherein at least one of said pressure chamber and said build platform is configured to move in at least one of the first direction, the second direction, and the third direction.

16. An additive manufacturing system defining a first, longitudinal direction, a second, transverse direction, and a third, vertical direction, said additive manufacturing system comprising:
a consolidation device configured to emit an energy beam; and
a pressurized consolidation assembly comprising:
a build platform configured to hold a plurality of particles; and
a pressure chamber surrounding said build platform and said consolidation device, said pressure chamber configured to retain a first volume of a gas having a first pressure.

17. A method of fabricating a component using an additive manufacturing system, said method including:
pressurizing a pressurized consolidation assembly, wherein the pressurized consolidation assembly includes:
a build platform configured to hold a plurality of particles; and
a pressure chamber surrounding the build platform and configured to retain a first volume of a gas having a first pressure, the pressure chamber including:
at least one energy beam window extending through a first section of the pressure chamber, the at least one energy beam window configured to enable an energy beam to pass through the at least one energy beam window to be incident on the plurality of particles on the build platform; and
at least one observation window extending through a second section of the pressure chamber, the at least one observation window configured to facilitate observation of the plurality of particles;
depositing a plurality of particles onto the build platform;
distributing the plurality of particles to form a build layer; and
operating a consolidation device to direct at least one energy beam through the at least one energy beam window to consolidate at least a portion of the build layer.

18. The method in accordance with claim 17, wherein pressurizing the pressurized consolidation assembly further comprises pressurizing the pressurized consolidation assembly with a gas at a first pressure of between approximately fourteen and a half psi and one hundred psi, and wherein the gas is a shielding gas including at least one of argon, carbon dioxide, helium, oxygen, nitrogen, nitric oxide, sulfur hexafluoride, and dichlorodifluoromethane.

19. The method in accordance with claim 17, wherein operating the consolidation device further comprises directing a laser beam through the at least one energy beam window to consolidate at least a portion of the build layer.

20. The method in accordance with claim 17, wherein pressuring the pressurized consolidation assembly further comprises pressurizing a second volume of the gas in flow communication with the first volume of the gas.
